(19) United States
(12) Patent Application Publication
(10) Pub. No.: US 2024/0326294 A1
(43) Pub. Date: Oct. 3, 2024

(54) VERTICAL STACKED PELLET PLANT

(71) Applicant: Enviva Inc., Bethesda, MD (US)

(72) Inventors: Norbert A. Hintz, Bethesada, MD (US); Isaac Kichak, Bethesada, MD (US); John Shellnutt, Bethesada, MD (US); Ryan Goodwin, Bethesada, MD (US)

(73) Assignee: Enviva Inc., Bethesda, MD (US)

(21) Appl. No.: 18/622,380

(22) Filed: Mar. 29, 2024

Related U.S. Application Data
(60) Provisional application No. 63/493,491, filed on Mar. 31, 2023.

(51) Int. Cl. B29B 9/14; B29B 9/06; B29B 9/16

(52) U.S. Cl. CPC B29B 9/14; B29B 9/06; B29B 9/16

(57) ABSTRACT

A process includes feeding a dry biomass feedstock from a dry fiber silo to a distribution conveyor system; feeding at least a portion of the dry biomass feedstock from the distribution conveyor system to at least one hammermill; grinding the dry biomass feedstock in the at least one hammermill, producing a ground dry fiber having a particle size smaller than a particle size of the dry biomass feedstock; feeding the ground dry fiber to an intermediate conveyor system; feeding at least a portion of the ground dry fiber from the intermediate conveyor system to at least one metering system; metering the ground dry fiber from the at least one meter system to a least one pellet mill; and forming a plurality of fiber pellets in the at least one pellet mill.

### CROSS-REFERENCE TO RELATED APPLICATIONS

The present application claims the benefit under 35 U.S.C. § 119 (e) to U.S. Provisional Application No. 63/493,491 filed on Mar. 31, 2023. The entire disclosure of the above-referenced application is incorporated herein by reference.

### FIELD OF THE DISCLOSURE

Embodiments disclosed herein relate generally to a process and system for turning wood or other biomass into pellets for downstream uses.

### BACKGROUND

Traditional pellet plants, as illustrated in FIG. 1, consist of several independent, decoupled processing units for drying 10, dry siloing 20, dry sizing 30, feed siloing 40, pelleting, cooling, and screening 50, and product storage 60.

Configured as individual process units requires significant area, extensive conveyor systems, and multiple storage silos, and increase process unit count. This approach is not only very capital intensive but is also energy inefficient. This inefficiency results in the sized wood losing an excessive amount of heat before it is ready to be compacted into a pellet. For this reason, a large consumption of steam and/or increased electrical energy (in kWhr/ton) is required to add back the lost energy (heat) during the transportation and pelletizing process step.

Accordingly, there exists a continuing need for improved wood pelletizing systems and processes.

### SUMMARY OF THE DISCLOSURE

According to one or more embodiments disclosed herein is a process and system for turning sustainable wood biomass into wood pellets.

In one or more aspects, embodiments disclosed herein relate to a process for producing pellets. The process includes feeding a dry biomass feedstock from a dry fiber silo to a distribution conveyor system; feeding at least a portion of the dry biomass feedstock from the distribution conveyor system to at least one hammermill; grinding the dry biomass feedstock in the at least one hammermill, producing a ground dry fiber having a particle size smaller than a particle size of the dry biomass feedstock; feeding the ground dry fiber to an intermediate conveyor system; feeding at least a portion of the ground dry fiber from the intermediate conveyor system to at least one metering system; metering the ground dry fiber from the at least one meter system to a least one pellet mill; and forming a plurality of fiber pellets in the at least one pellet mill.

In other aspects, embodiments disclosed relate to a system for producing pellets. The system includes a dry fiber silo configured to hold a dry biomass feedstock, a distribution conveyor system coupled to the dry fiber silo and configured to receive at least a portion of the dry biomass feedstock from the dry fiber solo, and at least one hammermill coupled to the distribution conveyor system and configured to grind the dry biomass feedstock, received from the distribution conveyor system, to produce a ground dry fiber having a particle size smaller than a particle size of the dry biomass feedstock. The system further includes a metering system configured to receive the ground dry fiber from the hammermill from an intermediate conveyor system coupled to the at least one hammermill and at least one pellet mill configured to form a plurality of fiber pellets using the ground dry fiber received from the metering system

Other aspects and advantages will be apparent from the following description and the appended claims.

### BRIEF DESCRIPTION OF DRAWINGS

FIG. 1 is a simplified process flow diagram of a system for pelletizing wood.

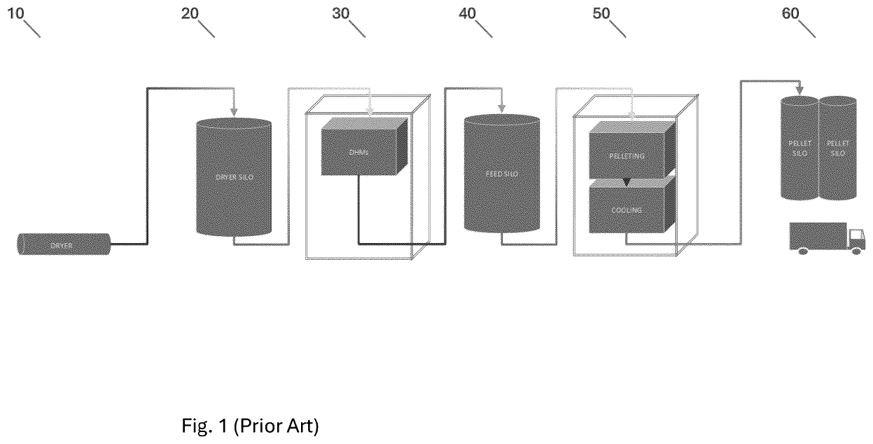

FIG. 2 is a simplified process flow diagram of a system for pelletizing wood according to embodiments herein.

FIG. 3 is a detailed process flow diagram of a system for pelletizing wood according to embodiments herein.

FIG. 4 is a detailed process flow diagram of a system for pelletizing wood according to embodiments herein.

### DETAILED DESCRIPTION

Embodiments herein relate generally to systems and processes for turning renewable, sustainable wood biomass into useful products such as wood pellets. Such wood pellets may be used, for example, as a replacement for coal in power plants or other commercial scale applications in which coal is used to heat power generating systems.

In one or more embodiments, raw materials include fiber from wood, tops and limbs, thinnings, and mill residues or other types of biomass material may be used. Such materials typically would be left behind or burned in the field during production of lumber-grade timber. In some embodiments, clear cut wood may also be used as raw material for the systems and processes disclosed herein.

Traditionally, wood pellets are made of woody biological material, such as tree bark, wood, saw dust, etc., which can be used in fuel plants for power generation, heating purposes, steam production, as a reducing agent, or as chemical feedstocks for alternative fuels such as Sustainable Aviation Fuels (SAF).

During recent years, there has been an increasing focus on the environment emissions, and especially emissions of “fossil” CO2. In many countries, great efforts are made in the transformation from use of fossil energy sources, such as oil, gas, coal and coke, to biological or renewable energy sources, in order to reduce the emissions of “fossil” CO2 in the individual country.

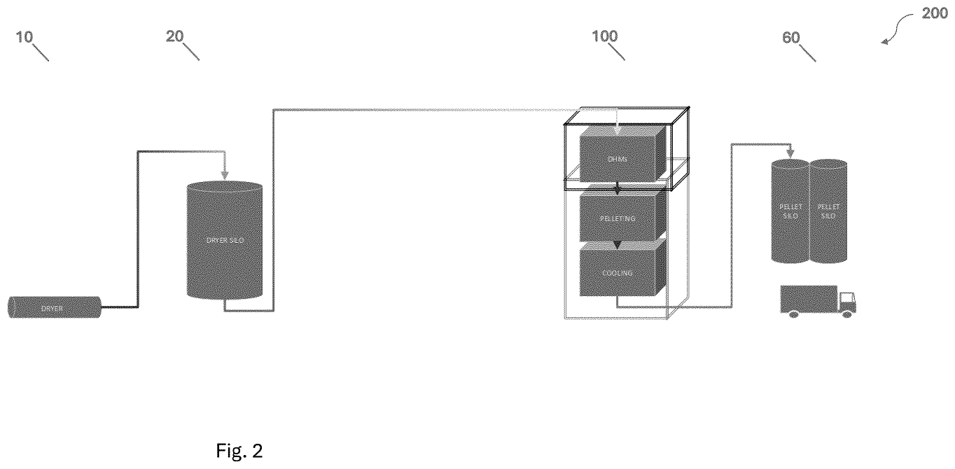

In order to improve the pelletizing process, embodiments disclosed herein utilize a compact stacked plant configuration 200, as illustrated in FIG. 2, where the dry sizing, pelleting, cooling, and screening are stacked vertically and directly coupled together in a single unit 100, eliminating the need for multiple silos, significantly reducing the number of required conveyors, and eliminating the associated heat loss (wasted energy) before pelletizing.

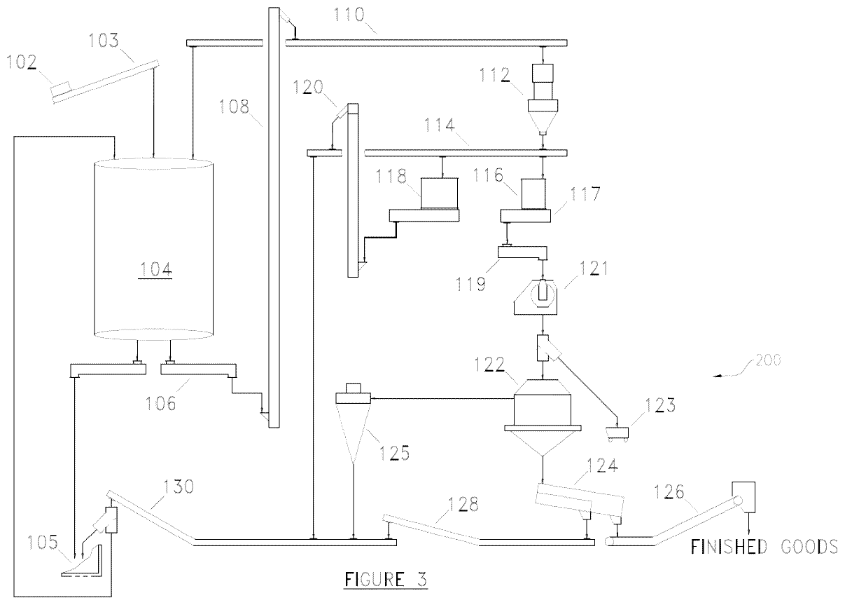

As illustrated in FIG. 3, a dry biomass feedstock 102 is fed from an upstream dryer system (not illustrated) to a dry fiber silo 104 using a dryer collection conveyor 103. Herein, any “conveyor” or “conveyor system” encompasses any conveyor system that allows for transport of material from one location to another and may have any configuration known in the art, e.g., a belt support, a pully, and a drive unit. In accordance with one or more embodiments, the dry biomass feedstock 102 may include fiber from wood, tops and limbs, thinnings, and mill residues or other types of biomass material without departing from the scope of the disclosure herein. In accordance with one or more embodiments, the dry biomass feedstock 102 in the dry fiber silo 104 has a moisture content in the range of 5 to 15 wt %.

In accordance with one or more embodiments, the dry fiber silo 104 is coupled to a dump bunker 105. The dump bunker 105 may be used to empty the dry biomass feedstock 102 from the dry fiber silo 104 during system upsets or for firefighting purposes. The system may also include multiple dump bunkers 105 coupled to various components of the system to empty the wood fiber from these points in the system during system upsets or for firefighting purposes. Various conveyors and elevators, not labeled, may be used to transport the wood fibers to the dump bunkers 105.

A portion of the dry biomass feedstock 102 is pulled from the bottom of the dry fiber silo 104 using a dry fiber silo discharge conveyor system 106. The portion of the dry biomass feedstock 102 pulled from the dry fiber silo 104 using the dry fiber silo discharge conveyor system 106 is then fed to a hammermill distribution conveyor system 110 using a transport elevator 108. Herein, any “elevator” or “elevator system” encompasses any elevator system that allows material to be lifted or lowered and may have any configuration known in the art, e.g., a cabin, cables, controls drive, counter weight, guide rails, etc.

The dry biomass feedstock 102 on the hammermill distribution conveyor system 110 is transported and fed to at least one hammermill 112. Any excess dry biomass feedstock 102 on the hammermill distribution conveyor system 110 which is not fed to the at least one hammermill 112 is returned to the dry fiber silo 104 through an overhead recycle line.

The at least one hammermill 112 operates by grinding or pulverizing the dry biomass feedstock 102, which has various sizes or ranges of size distributions, into a ground dry fiber. In accordance with one or more embodiments, the hammermill 112 may have any configuration known in the art, such as a series of horizontal hammers that force the dry biomass feedstock 102 through vertical screens to size/cut the wood fibers down to a desired particle size.

In some embodiments, the hammermill processes the feedstock with a size distribution from 0.25-1″ into a more uniform size distribution. In accordance with one or more embodiments, the size of the ground dry fiber is measured in percentages below 2 millimeters (mm). This is measured by passing samples of the ground dry fiber though different size sieves, for example, 4 mm, 2 mm, 1.4 mm, 0.5 mm, and 0.1 mm. In accordance with one or more embodiments, the “uniform size distribution” is having 100% of the ground dry fiber smaller than 4 mm (i.e., 100% of fibers passing thought the 4 mm sieve) and 85 to 96% of the ground dry fiber smaller than 2.0 mm (i.e., 85 to 96% of fibers passing through the 2.0 mm sieve).

Such hammermills may also have an air inlet for introduction of a motive fluid to dissipate the buildup of moisture (e.g., steam) that is released during the sizing. During the hammermill process, the dry biomass feedstock 102 may be heated to 150-180° F. The heating occurs as a result of the friction of pulverizing the larger dry biomass feedstock 102 particles into smaller, more uniform ground dry fiber particles.

This ground dry fiber is then dropped onto a distribution conveyor system 114. The distribution conveyor system 114 may contain the moisture and volatile organic compounds released during the pulverizing process, preventing the volatile organic compounds (VOCs) from being released to the environment. The distribution conveyor system 114 also separates out any metal contamination that might have been passed through or generated during the pulverizing process. Finally, the ground dry fiber is distributed to one or more pellet mill metering bins 116 located below the reception conveyor.

The distribution conveyor system 114 also may operate similar to the hammermill distribution conveyor system 110 in an over/under arrangement. Any excess ground dry fiber that cannot be collected in the at least one pellet mill metering bin 116 is collected in a pellet mill overflow bin 118 and be can recycled from the pellet mill overflow bin 118 directly to the distribution conveyor system 114 using an overflow elevator system 120. In some embodiments, the excess ground dry fiber may be returned to the dry fiber silo 104 as recycled or reworked material via a fines collection conveyor system 130. However, using the direct recycle to the distribution conveyor system 114 eliminates the need to route the excess back to the dry fiber silo 104 and thus eliminate unwanted rework and consequential additional reduction in particle size and required process energy in the at least one hammermill 112.

The ground dry fiber in the at least one pellet mill metering bin 116 is then fed to one or more pellet mills 121 vertically stacked below the at least one pellet mill metering bin 116. In accordance with one or more embodiments, the ground dry fiber is fed from the pellet mill metering bin 116 to the pellet mill 121 using a series of screw conveyors.

The screw conveyors and the pellet mill metering bins 116 make up the metering system. The metering system is configured to meter the ground dry fiber to the pellet mills. That is, the metering system is used to control the speed and amount of ground dry fiber being fed into the pellet mills 121. This may be performed using weight sensors, speed sensors, and a computer system. In accordance with one or more embodiments, one set of screw conveyors and pellet mill metering bin 116 may feed the ground dry fiber to one pellet mill 121 at a rate between 0 to 28,000 pounds per hour.

In accordance with one or more embodiments, the screw conveyors may include a feed control screw conveyor 117 and a conditioning screw conveyor 119. The feed control screw conveyor 117 is located along the vertical plane between the pellet mill metering bin 116 and the conditioning screw conveyor 119 and is used to feed the ground dry fiber from the pellet mill metering bin 116 to the conditioning screw conveyor 119. The conditioning screw conveyor 119 may introduce additional moisture, steam, or other products to the ground dry fiber to condition the fiber and to facilitate the palletization process. The conditioning screw conveyor 119 then feeds the ground dry fiber, including any additives, to the pellet mill 121. The feed control screw conveyor 117 and conditioning screw conveyor 119 may have any configuration known in the art, such as a trough (U shape) screw conveyor, a tubular screw conveyor, etc.

Pellet mills 121 used in embodiments disclosed may be flat die mills or ring die mills without departing from the disclosure herein. In accordance with one or more embodiments, flat die mills use a stationary flat die with holes. The ground dry fiber is introduced to the top of the die, and, as the pressing rollers rotate, the ground dry fiber is pressed through a series of holes in the die. A cutter on the bottom side of the die cuts the exposed pellet free from the die. In accordance with one or more embodiments, the formed pellets have a nominal size of 6-10 mm in diameter and 12-50 mm in length.

In accordance with one or more embodiments, ring die mills include radial holes located throughout the die. The ground dry fiber is fed into the inside of the die and spreaders evenly distribute the ground dry fiber. Stationary rollers then compress the ground dry fiber through a series of holes as the die rotates around the rollers. Cutters are used to cut the pellets free from the outside of the die. Like the flat die mill, the ring die mill may produce pellets have a nominal size of 6-10 mm in diameter and 12-50 mm in length.

Using either system, pellets having a desired sized can be produced. During the pellet mill process, the ground dry fiber is pushed through the press at high pressure which causes lignin, the natural adhesive in the wood particles that make up the ground dry fiber, to melt and flow between the wood fibers adhering them together to hold the pellet together.

In embodiments disclosed, by directly vertically coupling the hammermill distribution conveyor system 110 and the distribution conveyor system 114 to the hammermill 112, the pellet mill metering bins 116, and the pellet mills 121, very little energy is lost. As a result, the temperature of the ground dry fiber entering the pellet mill 121 is greater than 160° F. This eliminates the need for steam conditioning and results in a net reduction in energy (and thus CO2 emissions) to produce the pellet. Specifically, the higher inlet temperature of the material entering the pellet mills 121 reduces the amount of work required to bring the ground dry fiber up above the lignin melting temperature (e.g., above 170 degrees Fahrenheit). Without the present configuration, this work required to bring the ground dry fiber up above the lignin melting temperature must be provided by the pellet mill (resulting in loss t/hr capacity) or via the addition of heat (i.e. steam).

The formed pellets are released from the pellet mill and fed to one or more pellet coolers 122 located vertically below the one or more pellet mills 121. At least a portion, but optionally all, of the formed pellets are fed to the one or more pellet coolers 122. In some embodiments, a portion of the formed pellets are fed to a waste bin 123 during process upset conditions or during a spark/fire event in the pellet mill.

The one or more pellet coolers 122 cool the material to approximately atmospheric temperature. In accordance with one or more embodiments, the pellet coolers 122 draw ambient air up through a volume of pellets to cool the pellets and draw off excess moisture that is released during the pelleting process. The cooled pellets are then fed over at least one pellet screener 124 which separates desired sized pellets from pellets which are too small and loose material that was not pressed into a pellet. The desired sized pellets may have a particle distribution in the range of 6-10 mm in diameter and 12-50 mm in length. The desired size pellets separated by the pellet screener 124 may be called “overflow material.” The pellets which are too small (e.g., the pellets smaller than 3.15 mm as measured via a square sieve), the loose material that was not pressed into a pellet (e.g., wood fiber remnants), and wood dust (known as “fines”) are collectively known as “underflow material.”

The underflow material is collected from the pellet screener 124 (in the case of the undersized pellets and the other wood fiber remnants) and from the cyclone 125 at the air exhaust of the pellet cooler 122 (in the case of fines). The underflow material collected from the pellet screener 124 is fed to a screened fines conveyor system 128. The underflow material collected via the cyclone 125 of the air exhaust is collected on the fines collection conveyor system 130.

The underflow flow material on the screened fines conveyor system 128 may then be combined with the excess material from the distribution conveyor system 114 and the underflow material on the fines collection conveyor system 130. The combined material on the fines collection conveyor system 130 may then be recycled back to the top of the dry fiber silo 104 as recycled or reworked material. The overflow material from the one or more pellet screeners 124 are fed to a collection conveyor system 126 which transports the product wood pellets to a storage silo (not illustrated) before being sold and shipped as finished product.

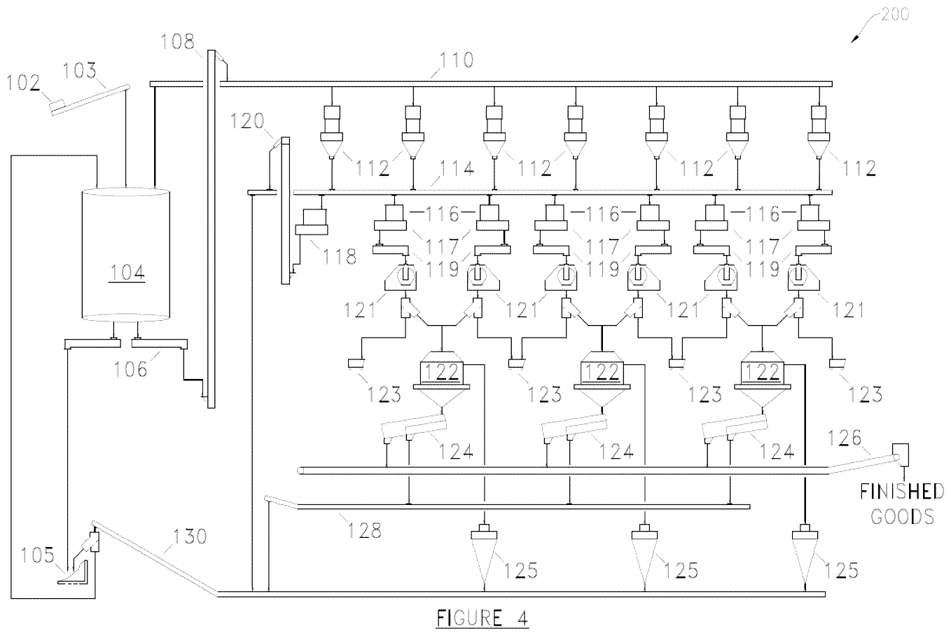

FIG. 4 illustrates a detailed process flow diagram of a system for pelletizing wood similar to FIG. 3, where like reference numerals represent like parts. Components shown in FIG. 4 that are the same as or similar to components shown in FIG. 3 are not redescribed for purposes of readability and have the same function and configuration as outlined in FIG. 3.

FIG. 4 outlines a more complex configuration of the compact stacked plant configuration 200 outlined in FIGS. 2 and 3. This configuration allows for the dry biomass feedstock 102 to be processed into pellets more efficiently and at a higher rate. FIG. 4 shows a dyer collection conveyor 103 transporting the dry biomass feedstock 102 to the dry fiber silo 104. FIG. 4 shows one dyer collection conveyor 103; however, a person skilled in the art will appreciate that any number of dyer collection conveyors 103 may be used without departing from the scope of the disclosure herein. The dry biomass feedstock 102 is pulled from the bottom of the dry fiber silo 104 using the dry fiber silo discharge conveyor system 106 and is fed to the hammermill distribution conveyor system 110 using the transport elevator 108.

The hammermill distribution conveyor system is coupled to a plurality of hammermills 112. Each hammermill 112 receives a portion of the dry biomass feedstock 102 to pulverize/grind into ground dry fiber. In other embodiments, one or more of the plurality of hammermills 112 may be used as a back-up in case one of the others becomes inoperable. Each hammermill 112 drops the ground dry fiber onto the distribution conveyor system 114. In one or more embodiments, between 2 and 30 hammermills 112 may be used.

The distribution conveyor system 114 is coupled to a plurality of pellet mill metering bins 116 and a portion of the ground dry fiber is distributed to each of the pellet mill metering bins 116. Each pellet mill metering bin 116 is coupled to a feed control conveyor 117, a conditioning screw conveyor 119, and a pellet mill 121. The feed control conveyor 117 and the conditioning screw conveyor 119 operate together to transport the ground dry fiber from the pellet mill metering bin 116 to the pellet mill 121. In one or more embodiments, between 2 and 16 pellet mill metering bins 116 may be used.

The system includes a plurality of pellet coolers 122. Each pellet cooler 122 is coupled to a plurality of pellet mills 121. For example, between 2 and 8 pellet coolers 122 may be used. Each pellet cooler 122 may be connected to 1 to 4 pellet mills 121. Each pellet cooler 122 is coupled to one or more pellet screeners 124 and one or more cyclones 125. The pellets are transferred from the pellet mills 121 to the pellet coolers 122. The pellets are cooled in the pellet coolers 122. The overflow material is separated from the underflow material using the pellet screeners 124 and the cyclones 125. The underflow material collected from the pellet screener 124 is fed onto the screened fines conveyer system 128. The underflow material collected from the cyclones 125 is distributed onto the fines collection conveyor system 130.

The underflow flow material on the screened fines conveyor system 128 may then be combined with the excess material from the distribution conveyor system 114 and the underflow material on the fines collection conveyor system 130. The combined material on the fines collection conveyor system 130 may then be recycled back to the top of the dry fiber silo 104 as recycled or reworked material. The overflow material from the one or more pellet screeners 124 are fed to a collection conveyor system 126 which transports the product wood pellets to a storage silo (not illustrated) before being sold and shipped as finished product.

Benefits of one or more embodiments herein may include:
Reduce equipment piece count by direct coupling of vertical hammermills to the pelleting process;
Conveyor buffering to optimize wood sizing process and eliminate rework of material;
Improved conveyor wet duct venting system to eliminate dust leaks and VOCs and control excess moisture;
Maximized heat retention translating to minimal kWhr of energy input per ton of pelleting process;
Minimized excess aspiration and use of RCO eliminates need for supplemental fossil fuels to control emissions.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A method for forming a biomass pellet, the method comprising:
feeding a dry biomass feedstock from a dry fiber silo to a distribution conveyor system;
feeding at least a portion of the dry biomass feedstock from the distribution conveyor system to at least one hammermill;
grinding the dry biomass feedstock in the at least one hammermill, producing a ground dry fiber having a particle size smaller than a particle size of the dry biomass feedstock;
feeding the ground dry fiber to an intermediate conveyor system;
feeding at least a portion of the ground dry fiber from the intermediate conveyor system to at least one metering system;
metering the ground dry fiber from the at least one metering system to at least one pellet mill; and
forming a plurality of fiber pellets in the at least one pellet mill.

2. The method of claim 1, further comprising transporting at least a portion of the ground dry fiber from a pellet mill overflow bin to the distribution conveyor system using an overflow elevator system and recycling at least a portion of the dry biomass feedstock and the portion of the ground dry fiber from the distribution conveyor system to the dry fiber silo.

3. The method of claim 1, wherein grinding the dry biomass feedstock further comprises heating the dry biomass feedstock to a temperature of at least 165 degrees Fahrenheit.

4. The method of claim 1, further comprising feeding the plurality of fiber pellets to at least one pellet cooler and cooling the plurality of fiber pellets to a temperature within 15 degrees Fahrenheit of an ambient temperature thereby producing a plurality of cooled fiber pellets.

5. The method of claim 4, further comprising screening the plurality of cooled fiber pellets using at least one pellet screener having square sieves to produce overflow material having a particle size larger than 3.15 mm as measured via the square sieves and underflow material having a particle size less than 3.15 mm as measured via the square sieves.

6. The method of claim 5, further comprising recovering the overflow material using a pellet collection conveyor to produce a fiber pellet product.

7. The method of claim 5, further comprising feeding a first portion of the underflow material to a screened fines conveyor system.

8. The method of claim 7, further comprising recovering a second portion of the underflow material from a cyclone coupled to an air exhaust of the at least one pellet cooler.

9. The method of claim 8, further comprising feeding the first portion of the underflow material from the screened fines conveyor system and the second portion of the underflow material from the cyclone to a fines collection conveyor system.

10. The method of claim 9, further comprising feeding the underflow material to the dry fiber silo.

11. A compact stacked plant comprising:
a dry fiber silo configured to hold a dry biomass feedstock;
a distribution conveyor system coupled to the dry fiber silo and configured to receive at least a portion of the dry biomass feedstock from the dry fiber silo;
at least one hammermill coupled to the distribution conveyor system and configured to grind the dry biomass feedstock, received from the distribution conveyor system, to produce a ground dry fiber having a particle size smaller than a particle size of the dry biomass feedstock;
a metering system configured to receive the ground dry fiber from the at least one hammermill from an intermediate conveyor system coupled to the at least one hammermill; and
at least one pellet mill configured to form a plurality of fiber pellets using the ground dry fiber received from the metering system.

12. The compact stacked plant of claim 11, wherein a portion of the dry biomass feedstock that is not fed to the at least one hammermill and a portion of the ground dry fiber that is not fed to the metering system are recycled back to the dry fiber silo.

13. The compact stacked plant of claim 11, wherein the dry biomass feedstock is configured to be heated to a temperature of at least 165 degrees Fahrenheit while being grinded by the at least one hammermill.

14. The compact stacked plant of claim 11, further comprising at least one pellet cooler coupled to the at least one pellet mill and configured to cool the plurality of fiber pellets to a temperature within 15 degrees Fahrenheit of an ambient temperature thereby producing a plurality of cooled fiber pellets.

15. The compact stacked plant of claim 14, further comprising at least one pellet screener coupled to the at least one pellet cooler having square sieves and configured to sort the plurality of cooled fiber pellets into an overflow material having a particle size larger than 3.15 mm as measured via the square sieves and an underflow material having a particle size less than 3.15 mm as measured via the square sieves.

16. The compact stacked plant of claim 15, further comprising a collection conveyer system coupled the at least one pellet screener and configured to recover the overflow material from an outlet of the at least one pellet screener to produce a fiber pellet product.

17. The compact stacked plant of claim 15, further comprising a screened fines conveyer system coupled to the at least one pellet screener and configured to recover a first portion of the underflow material from an outlet of the at least one pellet screener.

18. The compact stacked plant of claim 17, further comprising a cyclone coupled to the at least one pellet cooler and configured to recover a second portion of the underflow material from an air exhaust of the at least one pellet cooler.

19. The compact stacked plant of claim 18, further comprising a fines collection conveyor system configured to receive the first portion of the underflow material from the screened fines conveyor system and the second portion of the underflow material from the cyclone.

20. The compact stacked plant of claim 19, wherein the fines collection conveyor system is coupled to the dry fiber silo and is configured to transport the underflow material to the dry fiber silo to be recycled.
